(19) United States
(12) Patent Application Publication
(10) Pub. No.: US 2014/0352452 A1
(43) Pub. Date: Dec. 4, 2014

(54) SYSTEMS AND METHODS FOR MATERIALS TESTING

(71) Applicant: Varun Jain, Newport Beach, CA (US)

(72) Inventor: Varun Jain, Newport Beach, CA (US)

(21) Appl. No.: 13/903,185

(22) Filed: May 28, 2013

(51) Int. Cl. G01N 3/06; G01N 3/08

(52) U.S. Cl. CPC G01N 3/066; G01N 3/08
USPC 73/834; 73/866

(57) ABSTRACT

Systems and methods for materials testing are disclosed. According to one embodiment, a system for materials testing comprises a communication interface coupled to testing hardware, an electronic user interface for facilitating the input of production requirements and a specification, and a display device for displaying results of tests conducted on the testing hardware, wherein the results are based in part on the production requirements and specification.

### FIELD

The embodiments relate generally to testing systems, and more particularly to systems and methods for materials testing.

### BACKGROUND

Materials (biomaterials as well as inorganic or organic materials) and devices (integrated circuits, LED, Solar cell etc.) need analysis to assess product quality, functioning, safety, reliability and toxicity.

Tensile testing, also known as tension testing, is a fundamental materials science test in which a sample is subjected to a controlled tension until failure. The results from the test are commonly used to select a material for an application, for quality control, and to predict how a material will react under other types of forces. Properties that are directly measured via a tensile test are ultimate tensile strength, maximum elongation and reduction in area. From these measurements the following properties can also be determined: Young's modulus, Poisson's ratio, yield strength, and strain-hardening characteristics.

A tensile specimen is a standardized sample cross-section. It has two shoulders and a gauge (section) in between. The shoulders are large so they can be readily gripped, whereas the gauge section has a smaller cross-section so that the deformation and failure can occur in this area.

### SUMMARY

Systems and methods for materials testing are disclosed. According to one embodiment, a system for materials testing comprises a communication interface coupled to testing hardware, an electronic user interface for facilitating the input of production requirements and a specification, and a display device for displaying results of tests conducted on the testing hardware, wherein the results are based in part on the production requirements and specification.

The systems, methods, features and advantages of the invention will be or will become apparent to one with skill in the art upon examination of the following figures and detailed description. It is intended that all such additional methods, features and advantages be included within this description, be within the scope of the invention, and be protected by the accompanying claims. It is also intended that the invention is not limited to require the details of the example embodiments.

### BRIEF DESCRIPTION

The accompanying drawings, which are included as part of the present specification, illustrate the presently preferred embodiment and, together with the general description given above and the detailed description of the preferred embodiment given below, serve to explain and teach the principles of the present invention.

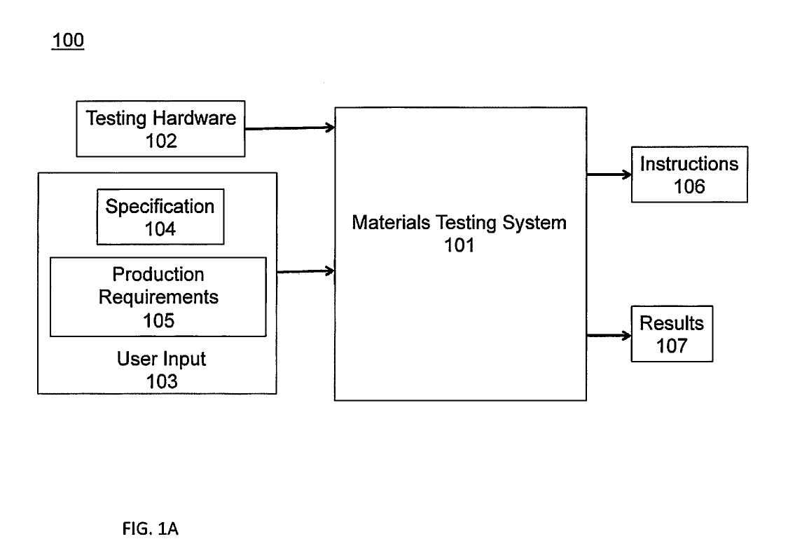

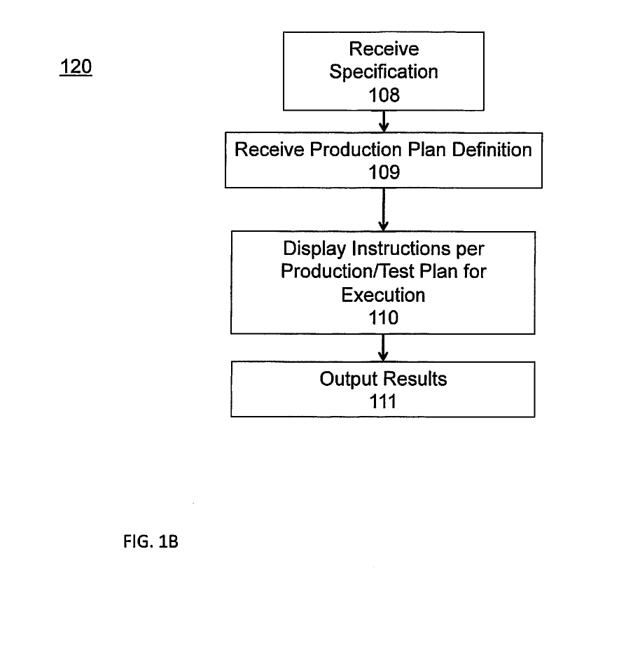

FIG. 1A illustrates an exemplary system level overview of a materials testing system, according to one embodiment.

FIG. 1B illustrates an exemplary materials testing process for use with the present system, according to one embodiment.

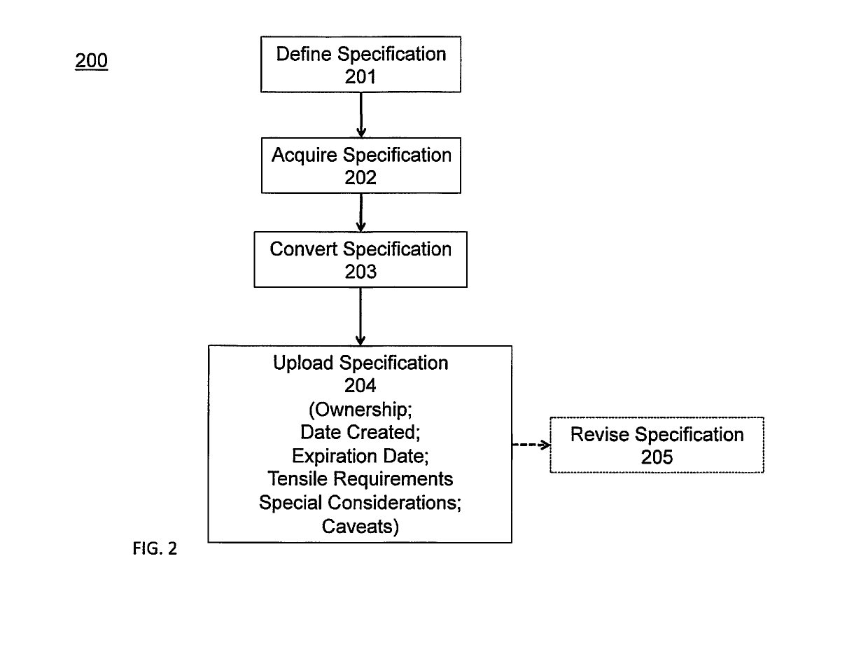

FIG. 2 illustrates an exemplary specification upload process for use with the present system, according to one embodiment.

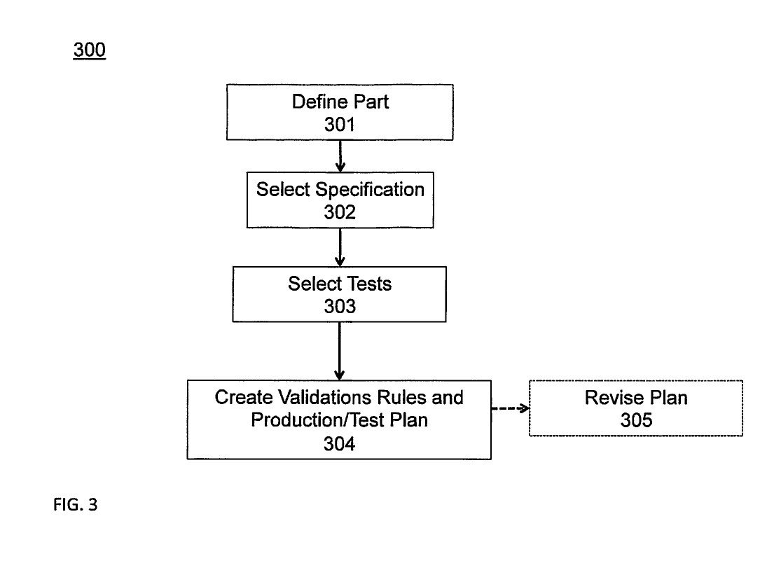

FIG. 3 illustrates an exemplary production plan definition process for use with the present system, according to one embodiment.

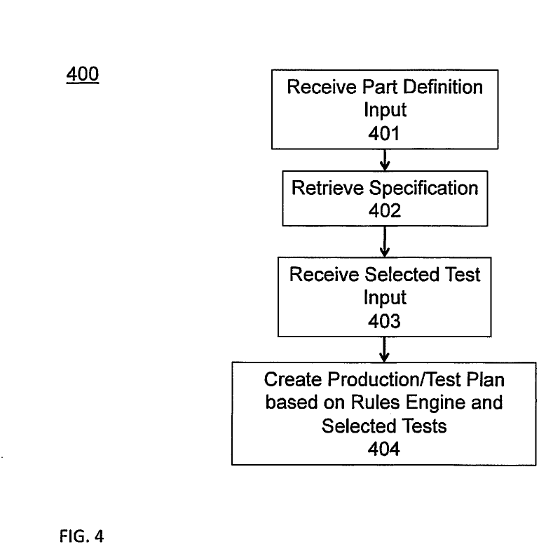

FIG. 4 illustrates an exemplary production plan creation process for use with the present system, according to one embodiment.

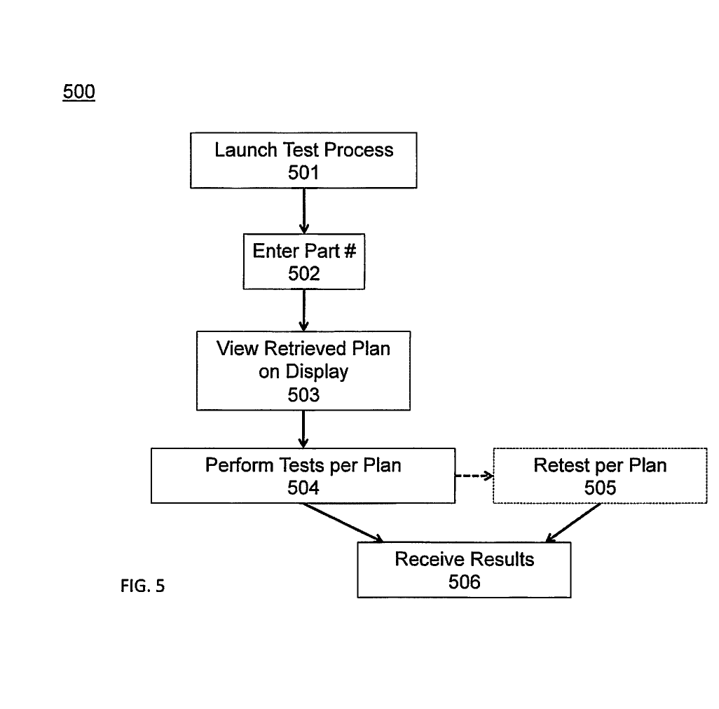

FIG. 5 illustrates an exemplary user-side test process for use with the present system, according to one embodiment.

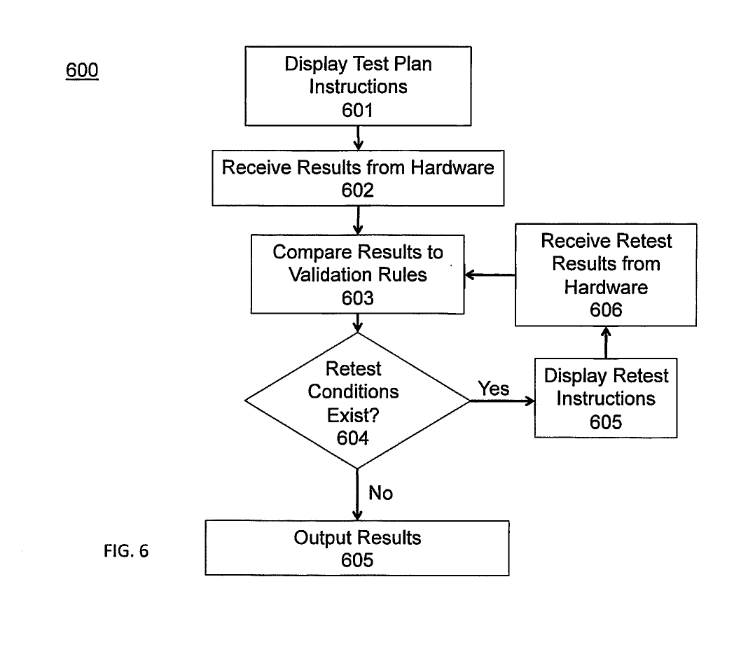

FIG. 6 illustrates an exemplary software-side test process for use with the present system, according to one embodiment.

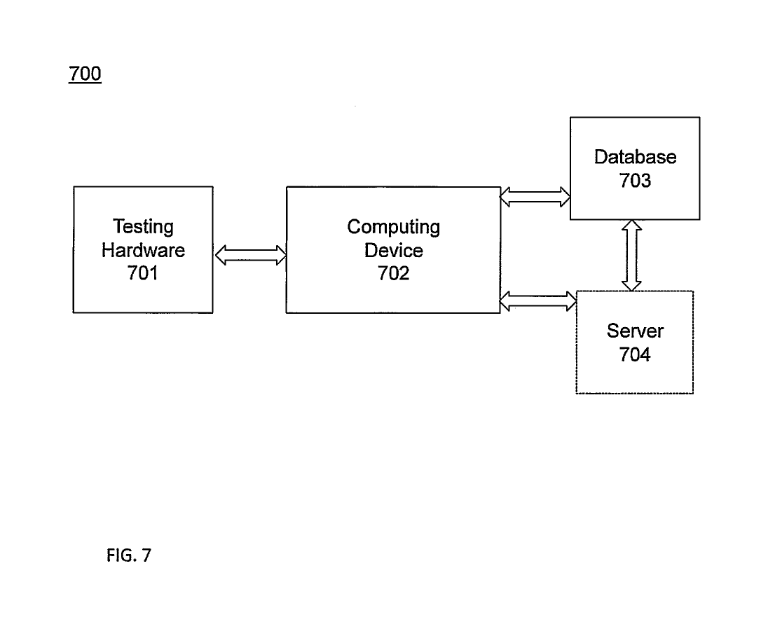

FIG. 7 illustrates an exemplary network communication overview for use with the present system, according to one embodiment.

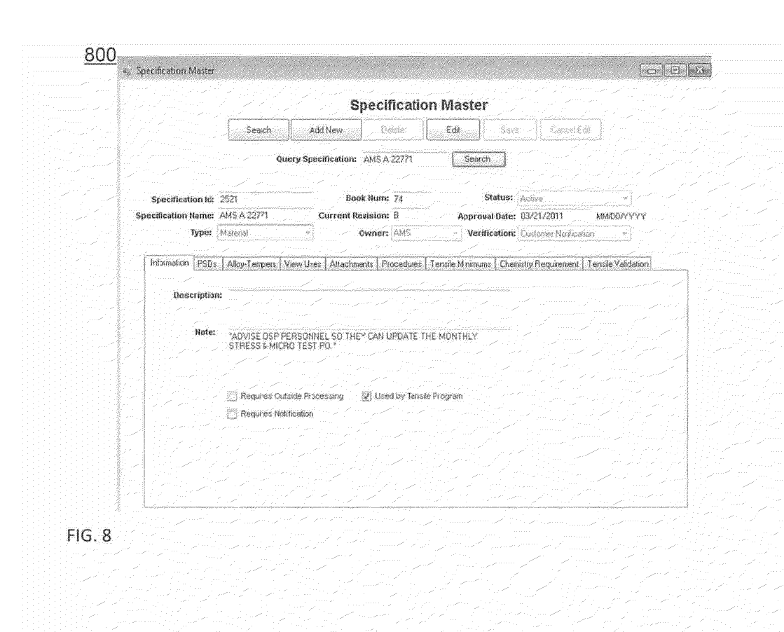

FIG. 8 illustrates an exemplary specification master interface for use with the present system, according to one embodiment.

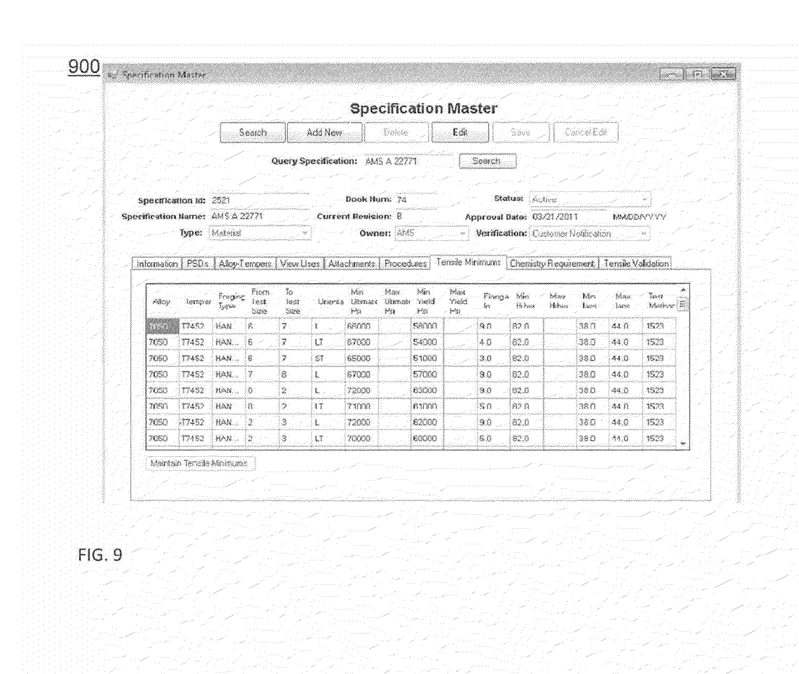

FIG. 9 illustrates an exemplary tensile minimums interface for use with the present system, according to one embodiment.

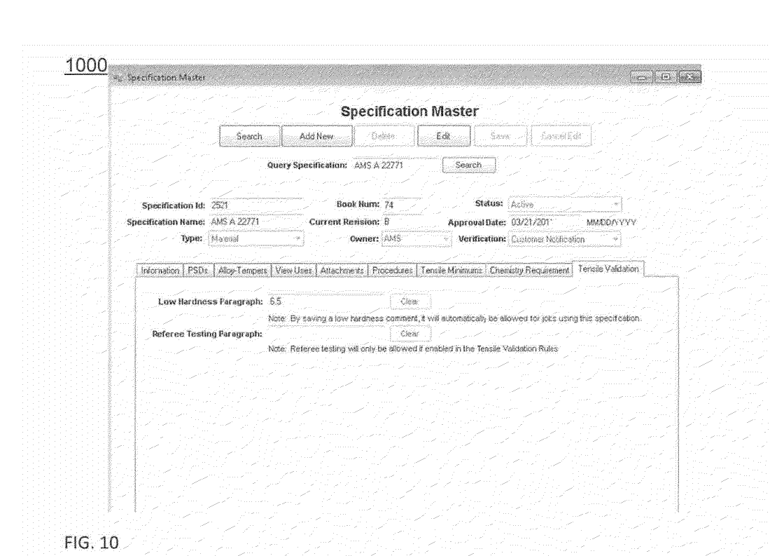

FIG. 10 illustrates an exemplary tensile validation interface for use with the present system, according to one embodiment.

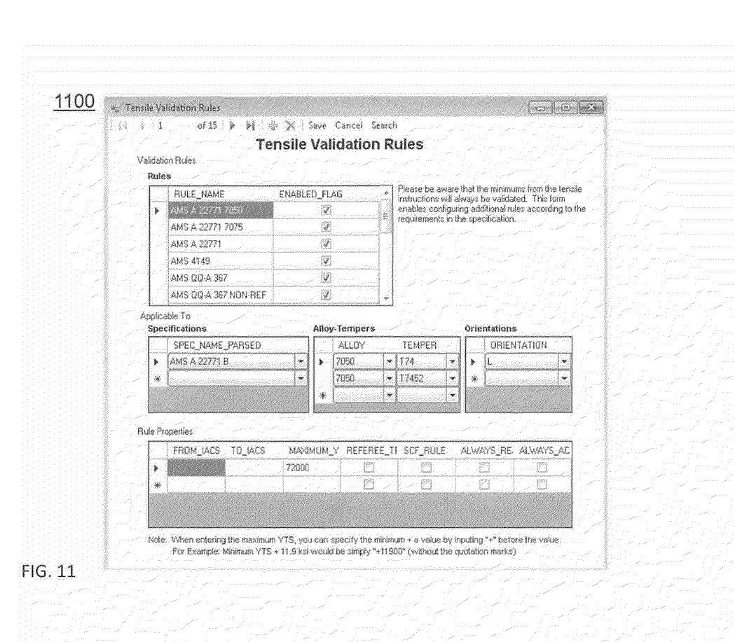

FIG. 11 illustrates an exemplary tensile validation rules interface for use with the present system, according to one embodiment.

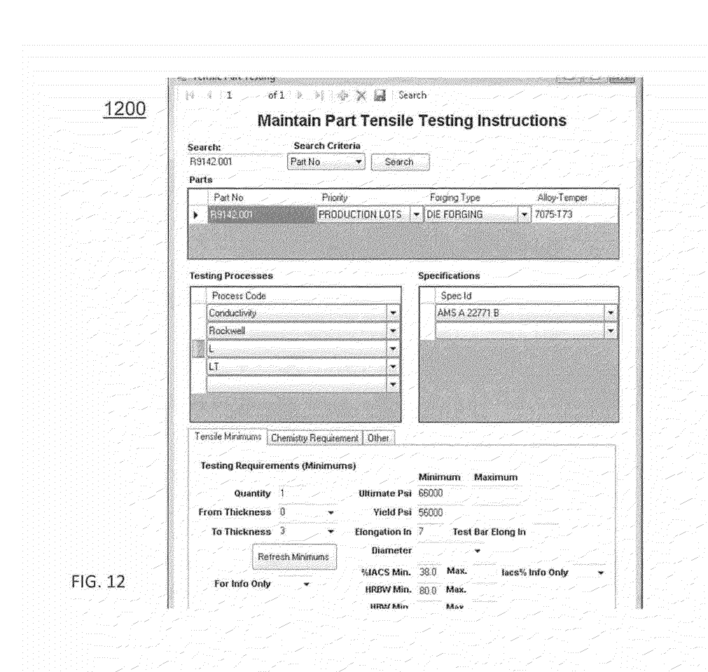

FIG. 12 illustrates an exemplary part planning interface for use with the present system, according to one embodiment.

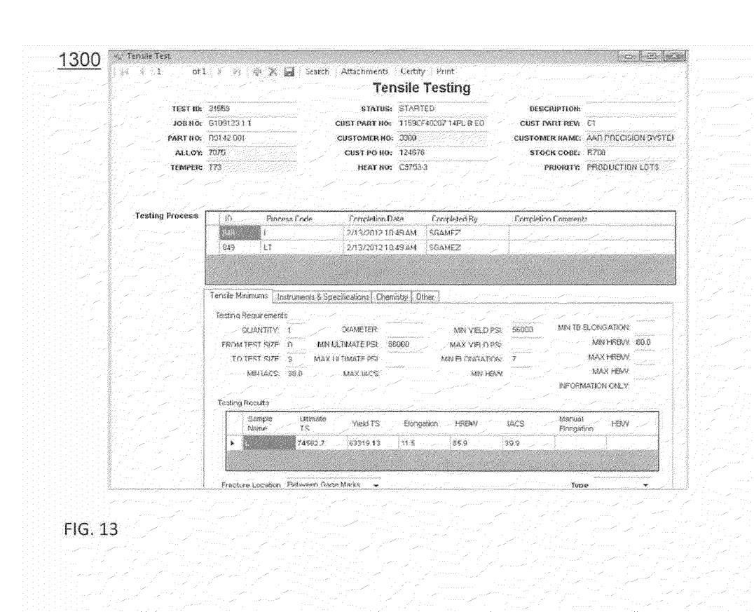

FIG. 13 illustrates an exemplary lab workbench interface for use with the present system, according to one embodiment.

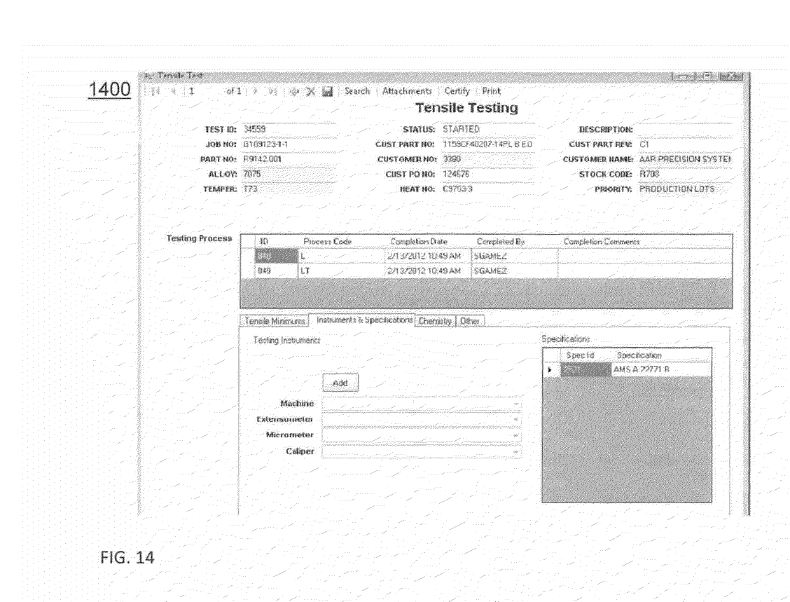

FIG. 14 illustrates an exemplary instruments and specifications interface for use with the present system, according to one embodiment.

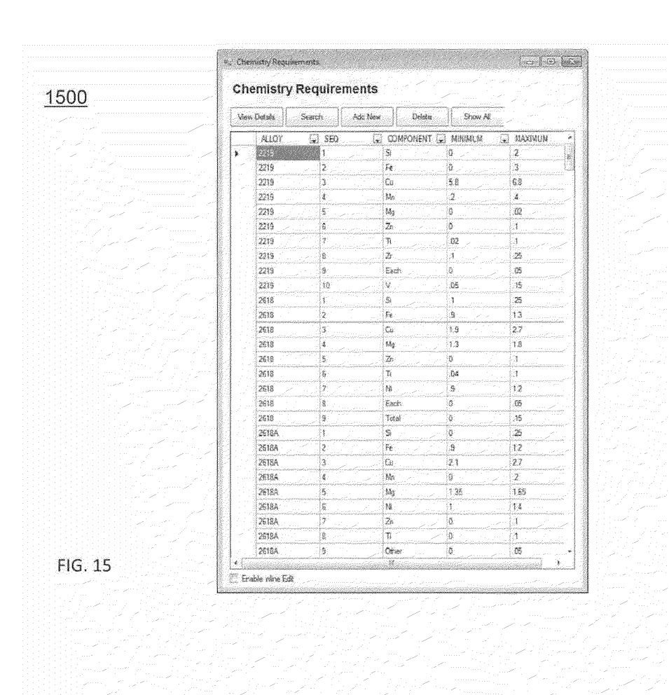

FIG. 15 illustrates an exemplary chemistry requirements interface for use with the present system, according to one embodiment.

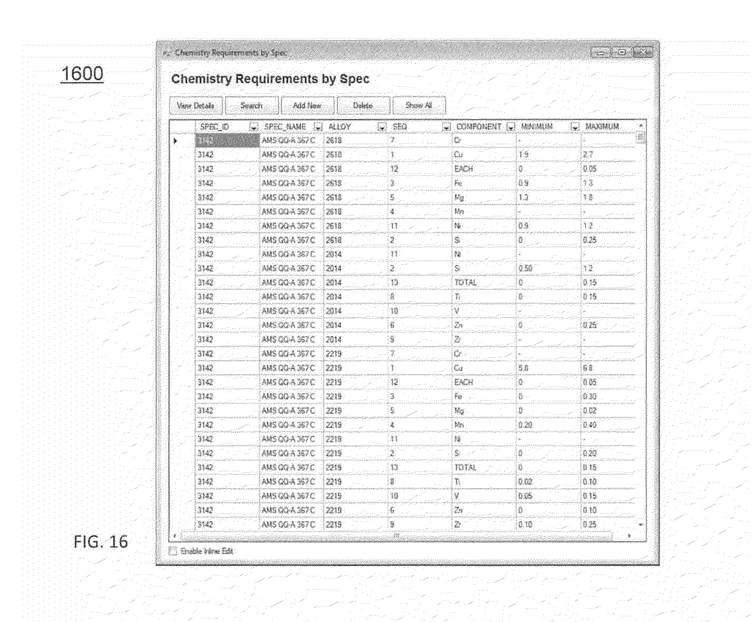

FIG. 16 illustrates another exemplary chemistry requirements interface for use with the present system, according to one embodiment.

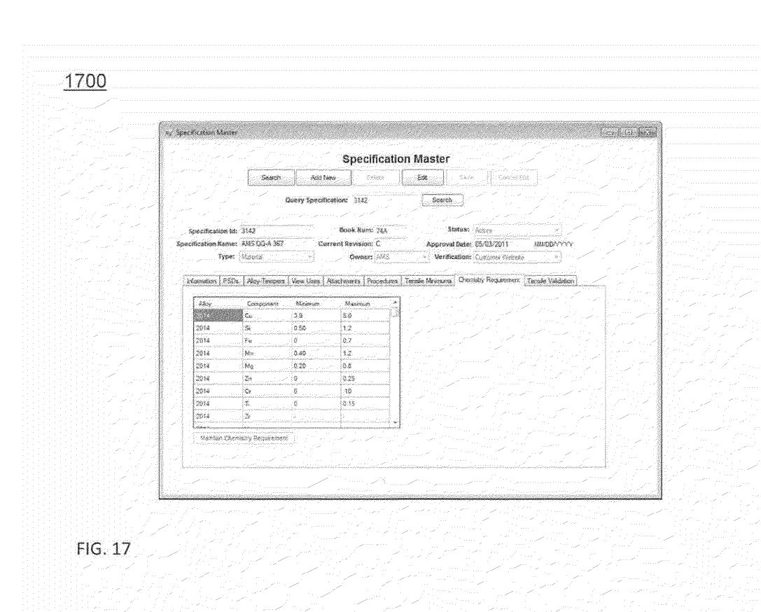

FIG. 17 illustrates a specification master interface for defining chemistry requirements, according to one embodiment.

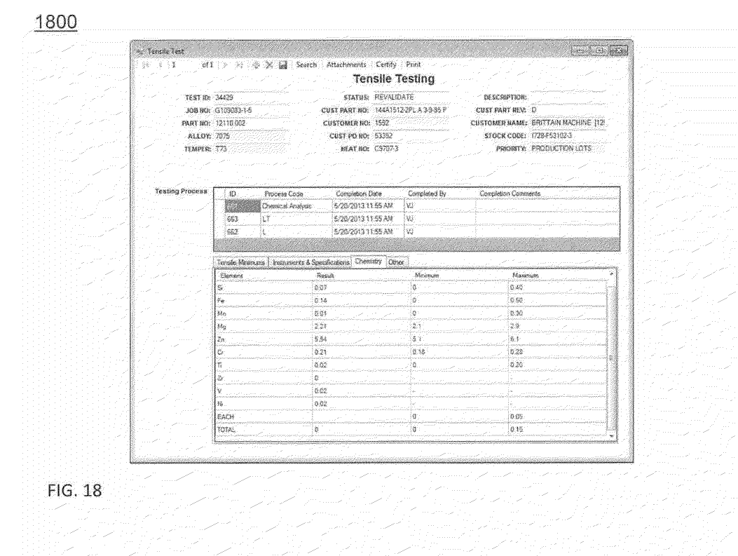

FIG. 18 illustrates a corresponding testing workbench interface with chemistry requirements imported and validated (corresponding to FIG. 17), according to one embodiment.

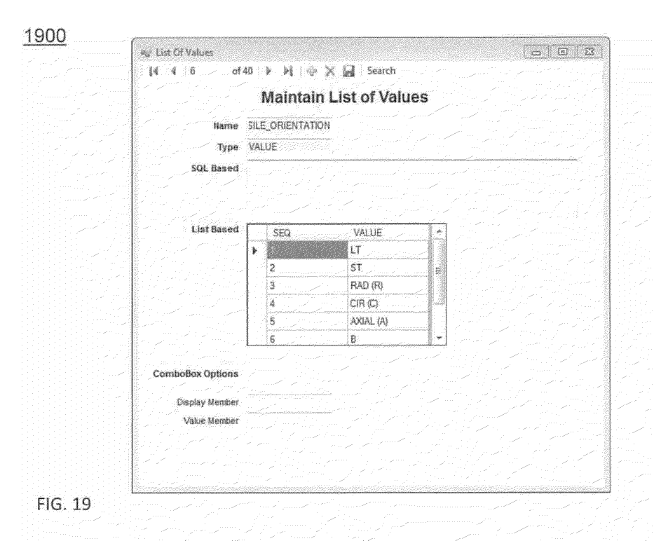

FIG. 19 illustrates an exemplary value list management interface for use with the present system, according to one embodiment.

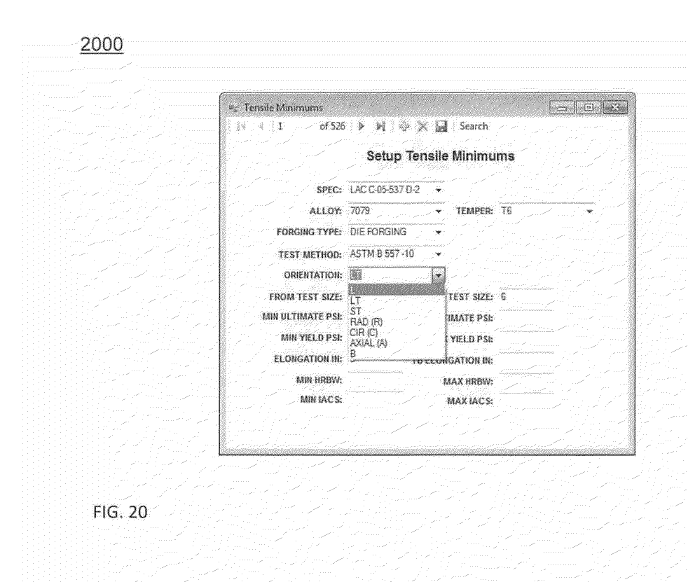

FIG. 20 illustrates an exemplary interface including a list of values corresponding to FIG. 19 for use with the present system, according to one embodiment.

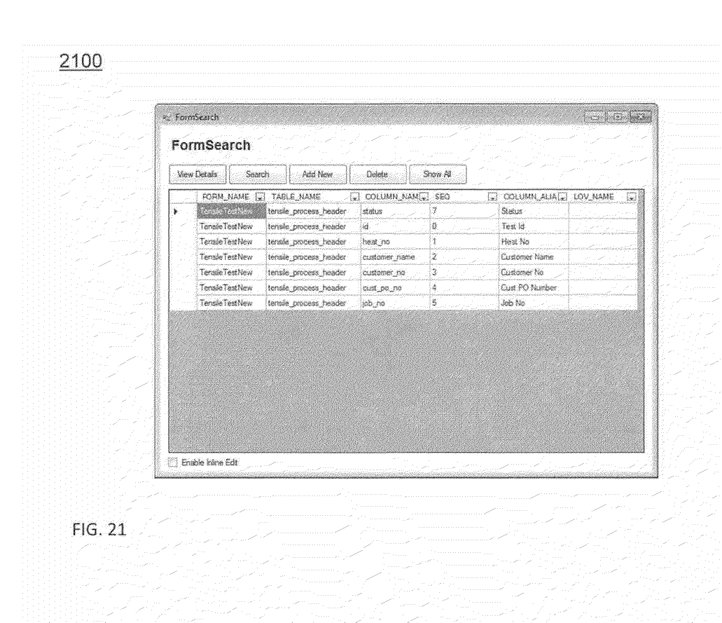

FIG. 21 illustrates an exemplary parameter and field definition interface for use with the present system, according to one embodiment.

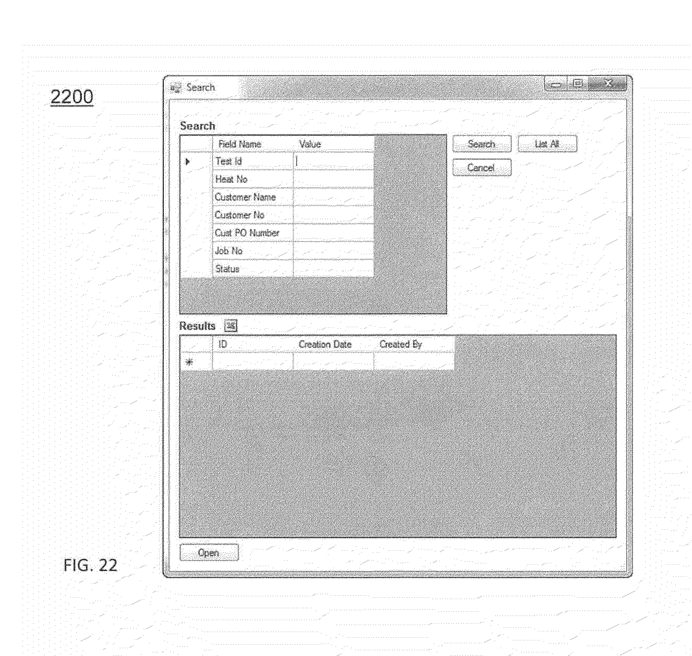

FIG. 22 illustrates exemplary search functionality within a workbench interface according to definitions of FIG. 21, according to one embodiment.

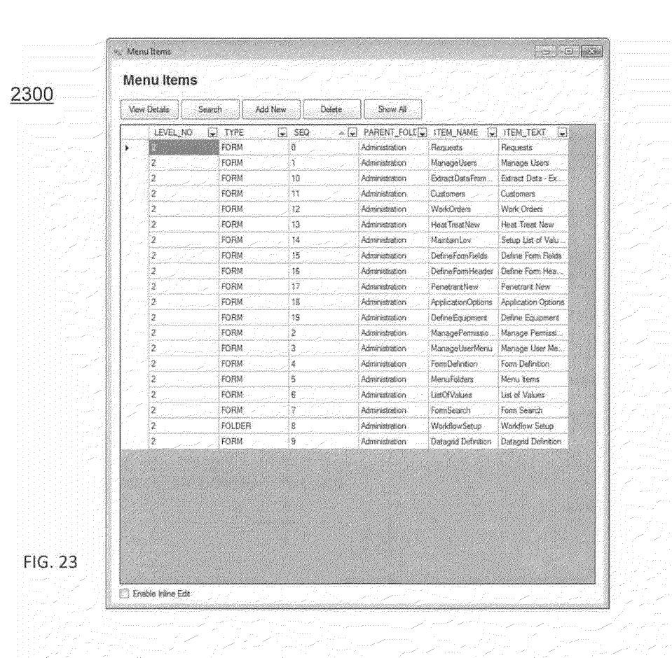

FIG. 23 illustrates an exemplary menu navigation management interface for use with the present system, according to one embodiment.

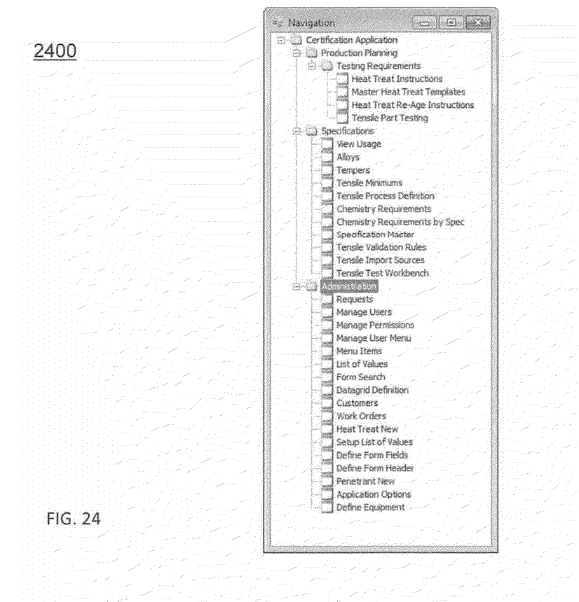

FIG. 24 illustrates an exemplary navigation bar within an administration interface according to definitions in FIG. 23, according to one embodiment.

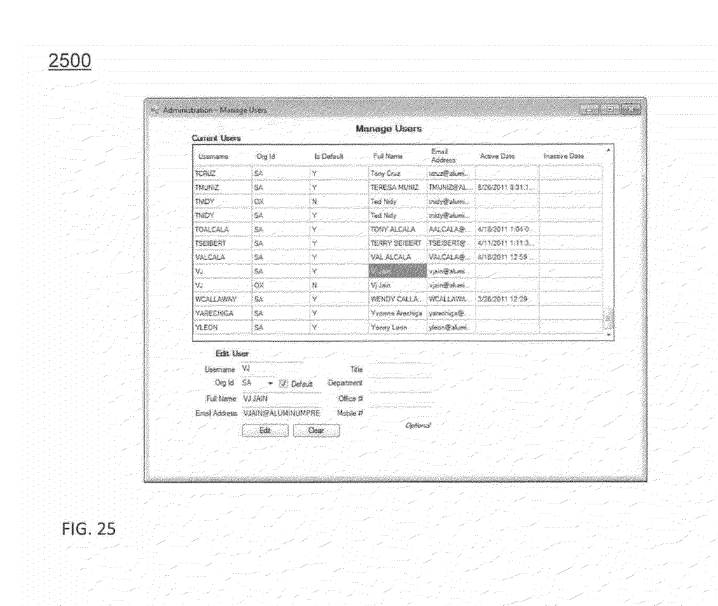

FIG. 25 illustrates an exemplary user management interface for use with the present system, according to one embodiment.

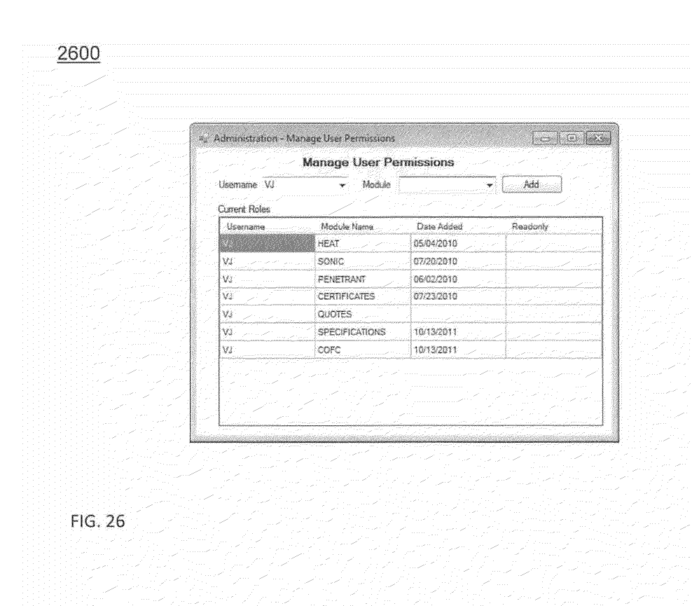

FIG. 26 illustrates an exemplary user permissions management interface for use with the present system, according to one embodiment.

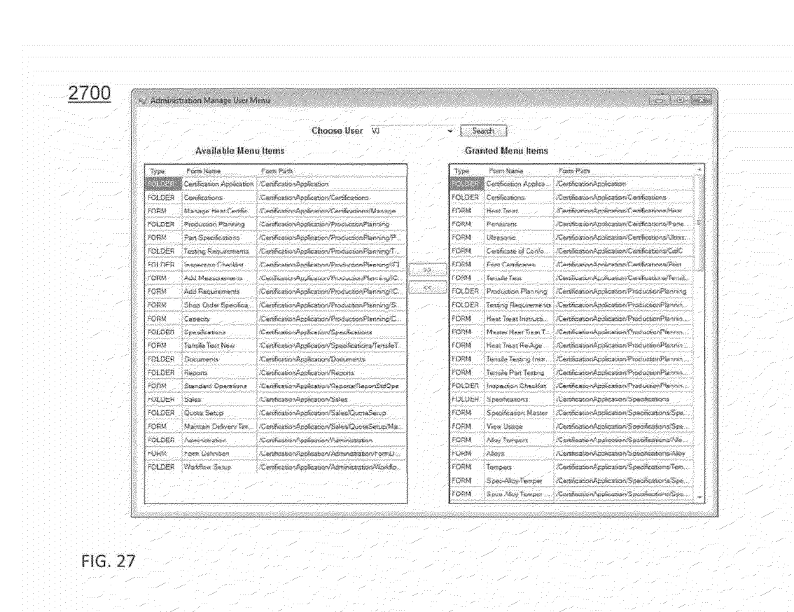

FIG. 27 illustrates an exemplary user menu management interface for use with the present system, according to one embodiment.

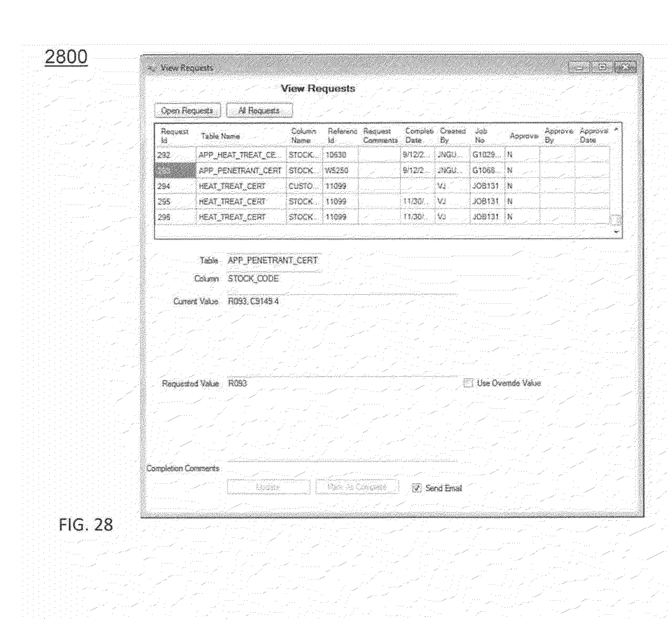

FIG. 28 illustrates an exemplary certificate request management interface for use with the present system, according to one embodiment.

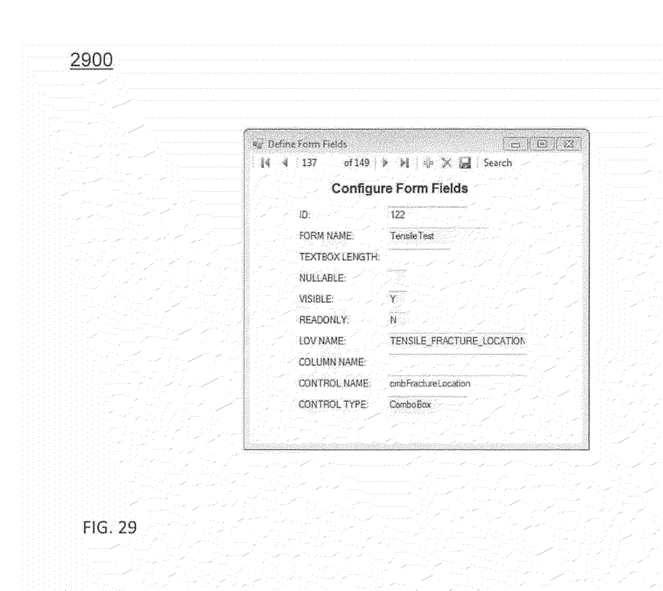

FIG. 29 illustrates an exemplary flexible fields management interface for use with the present system, according to one embodiment.

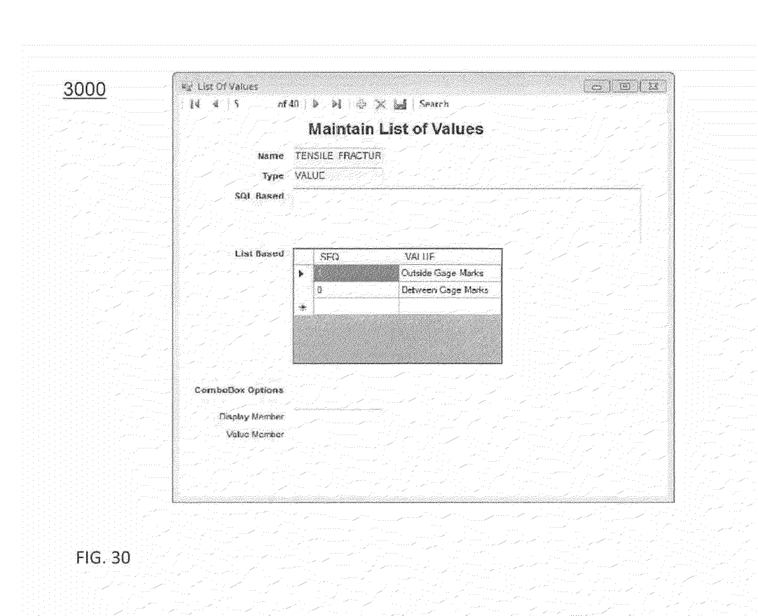

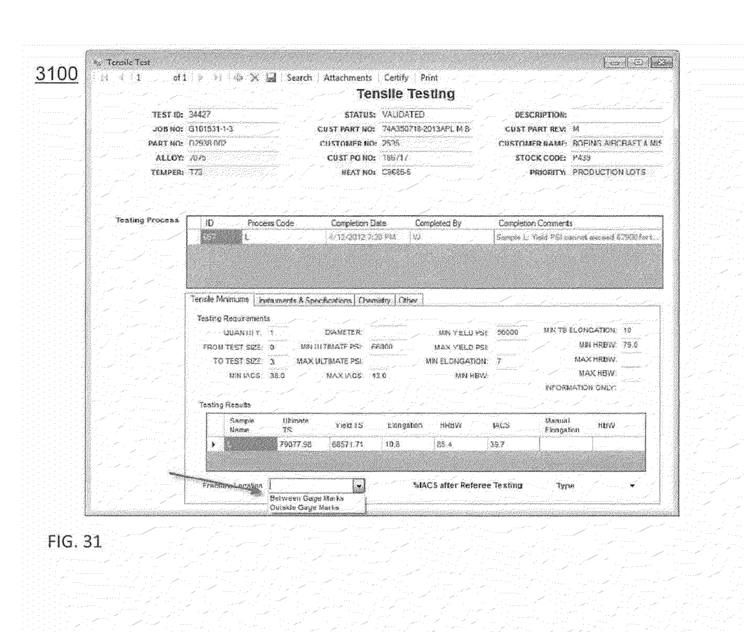

FIGS. 30-31 illustrate exemplary display of fields according to FIG. 29 within a workbench interface, according to one embodiment of the present system.

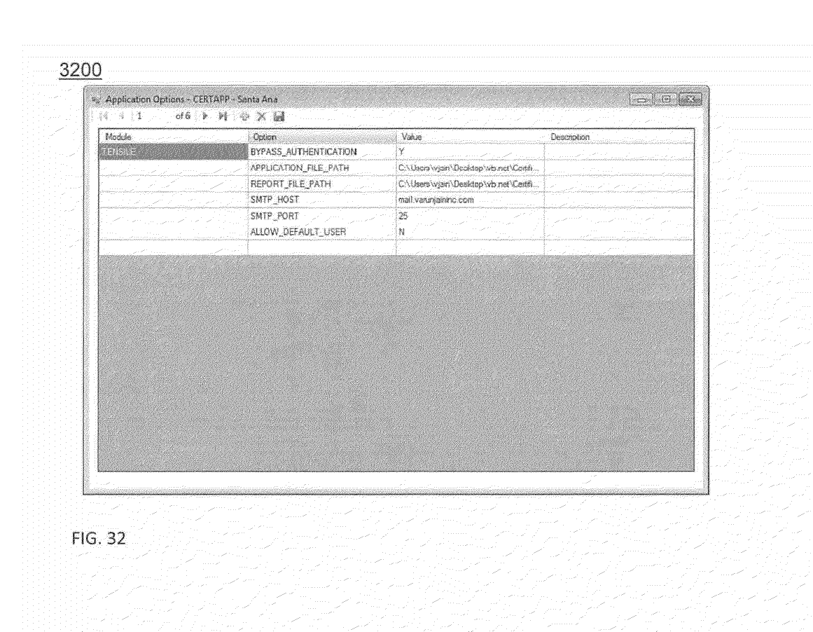

FIG. 32 illustrates an exemplary application options definition interface for use with the present system, according to one embodiment.

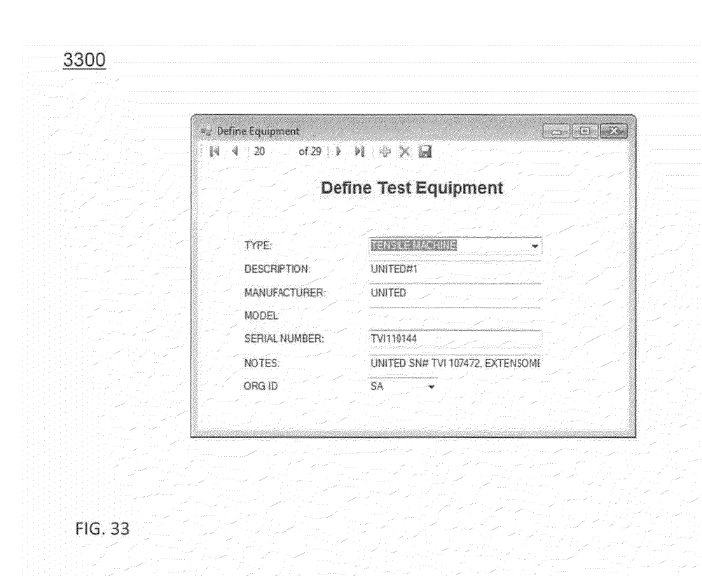

FIG. 33 illustrates an exemplary test equipment definition interface for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION

Systems and methods for materials testing are disclosed. Embodiments herein can be directed to materials testing including concretes, plastics, and metallic materials. Materials tests can include tensile testing, non-destructive testing (NDT), flexture testing, or testing of surface fixture, grain size, inclusion content, decarburization, structure, coercivity, as examples. Although embodiments presented herein are described as examples of tensile testing systems, it will be appreciated that the present disclosure can be applied to any appropriate materials test without departing from the scope of the disclosure.

The present systems and methods are directed to materials testing of metallic materials. FIG. 1A illustrates an exemplary system level overview 100 of a materials testing system, according to one embodiment. The materials testing system 101 receives user input 103 and results from testing hardware 102. The user input 103 comprises, according to an exemplary embodiment, a specification 104 and production requirements 105. It will be appreciated that the specification 104 and production requirements 105 can be uploaded manually or automatically (by a user or some other module or entity). Results from testing hardware 102 vary depending on the hardware used for testing. The materials testing system 101 delivers instructions 106 for execution of a test plan and ultimately outputs results 107 of the tests performed.

FIG. 1B illustrates an exemplary materials testing process 120 for use with the present system, according to one embodiment. The materials testing system receives a specification 108, and receives a production plan definition 109. The materials testing system then displays instructions for the created test/production plan to be executed 110, and outputs test results 111 upon completion of the test/production plan.

Standard functionality is provided for many part specifications and additional specifications can be easily configured. For each specification, minimums and maximums for ultimate tensile strength, yield tensile strength, elongation, hardness, and conductivity are setup by forging type and thickness. Test results, conductivity, hardness, and chemical analysis results are automatically imported and validated according to the specifications for each specimen/process. Once the job has been validated, it can be certified and printed.

According to one embodiment, tensile machines, spectrometers, and other testing machines are interfaced with the present system so that test results can be automatically imported and validated according to the test requirements. The test requirements are based on the configuration of the specifications. The test requirements can be modified to meet customer requirements if they differ from the specification. Using the present system, configurations and minimums are manageable by users. This allows jobs to be processed through test labs quickly, minimizing potential errors by lab operators.

According to one embodiment, data from all tests and validation results are stored in the present system, simplifying Failure Analysis (FA) Investigations. Using the stored information, problems in the lab can be quickly identified (such as equipment or procedural errors). If heat treating is performed in-house, then the failure analysis can be used to adjust heat treat and age cycles, minimizing the cost of rework and delivery times.

The present system not only improves efficiency, traceability, and reliability, but it also greatly reduces the chance of making errors that could be flagged by auditors and customers.

FIG. 2 illustrates an exemplary specification upload process 200 for use with the present system, according to one embodiment. A specification is defined 201 and then acquired 202 by a user or administrator. The specification is converted 203 to digital format so that it may be uploaded 204 to the tensile testing system. Optionally, the specification may be revised 205.

FIG. 3 illustrates an exemplary production plan definition process 300 for use with the present system, according to one embodiment. A user defines a part 301, including a part number, part name, and a batch number (all as examples). The user selects a specification that the part must comply with 302, and also the tests to be performed 303. A production plan and validation rules are created 304, and may optionally be revised 305 by the user.

According to one embodiment, the production plan definition process 300 takes place in an exemplary part testing workbench interface (a user accesses the process via the interface). This includes the necessary processes, quantity, diameter, minimums, and maximums. The tensile minimums can be defaulted from the specification setup according to alloy, temper, forging type, thickness, and orientation. The user may add specifications to each process. As an example, for chemical analysis, the requirements are defaulted from the chemistry by specification setup. For each tensile process, the requirements are defaulted and can be overridden based on the customer's requirement for the particular part.

The planning can also be setup to print values in MPa instead of PSI. Email notifications can be setup to send to designated users upon completion of the test. This helps to prevent delays in shipments due to a lack of communication.

FIG. 4 illustrates an exemplary production plan creation process 400 for use with the present system, according to one embodiment. While the production plan definition process 300 depicted in FIG. 3 above is from a user's perspective, the production plan creation process 400 is from a system perspective. The materials testing system receives part definition input 401 from the user, and retrieves the selected specification 402 as indicated by the user. The materials testing system receives input from the user indicating tests to be included 403. A production/test plan is created based on the specification and selected tests 404.

Validation rules are created to handle specification requirements that go beyond checking that the actual results are within the minimum and maximums. While the option for referee testing and low hardness are configured in the specification master (as an example), the validation rules are setup in a testing configuration. The validation rules are flexible to allow for many different requirements. One or more rules can be created for each specification or multiple specifications on the same rule.

A validation rule is matched by the specification, alloy-temper, orientations, and conductivity range. Each rule can be configured to check one or more conditions. For example, the Yield Strength can be configured such that it cannot exceed the “Minimum Yield Strength+119000” or a maximum yield strength can be designated for that rule (e.g. do not exceed). These rules are matched and checked during the validation process.

The validation rules are essentially a digital representation of the specification requirements. By using the validation rules, the process of validation is automated, streamlining jobs in the lab and minimizing the chance of errors.

FIG. 5 illustrates an exemplary user-side test process 500 for use with the present system, according to one embodiment. A user launches a test workbench interface 501, and enters a part number 502 (the part being ready to test in the tensile lab). The production/test plan is retrieved and populated or displayed from the work orders and the testing requirements; and viewed by the user 503. The user performs the tests per the plan instructions 504, and retests when necessary 505. The tensile results are imported and validated from the test machines. The results are received by the user 506.

FIG. 6 illustrates an exemplary software-side test process 600 for use with the present system, according to one embodiment. While the test process 500 depicted in FIG. 5 is from the user perspective, the test process 600 is from the system perspective. The materials testing system displays instructions contained in the test plan 601, and receives test results from the hardware upon completion of tests 602. The results are compared to the validation rules 603 (according to the test requirements and the specification rules), and the system determines whether the test meets the minimum requirements, requires re-work, or is eligible for a referee test (manual elongation measurements, invalid samples, etc.). If retest conditions exist 604 for the particular test/part/parameter, retest instructions are displayed 605. Retest results are received from the hardware 606 and compared to the validation rules 603 (and the process continues). If retest conditions do not exist 604, the results are output and/or displayed 605 according to configuration settings.

The data imports are setup during the implementation and can be maintained in the system. The validation results can be viewed for each sample and show the criteria and validation rule that was used. The lab technician, or user, only needs to enter a minimal amount information such as the fracture location and which equipment was used.

Once the test has been validated (see FIG. 10), it can be certified by an authorized lab operator. The certificate is prepared as an electronically signed PDF document that includes all of the necessary information for the materials test. The reports are customized during the installation. The certificate identifies the specifications, fracture location, test equipment for each sample, test minimums and actual results. The certificate also includes specifications required clauses for low hardness and referee testing if they are needed, in one embodiment.

According to one embodiment, a standard certificate includes the data necessary according to ASTM B557-10 10.2. However, a standard certificate can be modified to meet various requirements. The certificates are written into a table that prevents deletion and is revision controlled for traceability.

Examples of test standards include:
ASTM B557; and
ASTM E8.

Examples of customer specifications include:
AMS A 22771;
AMS 4107;
AMS 4108;
AMS 4149;
AMS QQ-A 367;
BMS 7-186;
BMS 7-214; and
HMS 1-1119.

FIG. 7 illustrates an exemplary network communication overview for use with the present system, according to one embodiment. A computing device 702 configured to support a testing system according to the present disclosure is in communication with testing hardware 701. The computing device 702 may, according to one embodiment, singularly handle all storage and processing of data. The computing device 702 may, according to an alternate embodiment, be in communication with a local server 704 and local database 703. According to yet another embodiment, the computing device 702 may be in communication over a network with the server 704 to provide for a more cloud based computing situation. The database 703 may be local to either the computing device 702 or the server 704.

Examples of test machines for use with the present system include tensile testing machines, spectrometers, high resolution cameras, among others.

Examples of manufacturers of test machines for use with the present system include, yet are not limited to United Testing Machines, MTS Test Systems, and Spectro.

Examples of additional modules for use with the present system include microstructure evaluation, grain flow analysis. These modules may not necessarily result in automated pass/fail output due to the fact that they include inspection of high resolution images. Pass/fail may be at the discretion of the operator.

FIG. 8 illustrates an exemplary specification master interface 800 for use with the present system, according to one embodiment.

According to one embodiment, specifications serve as the basis for all other functions. Included in an exemplary specifications interface are the specification master (800), tensile minimums (900), chemistry requirements, usage drilldown, and a read-only viewer.

According to one embodiment, a specification master interface (800) provides for the creation and maintenance of specifications. Information such as the specification's owner, type, verification method, approval date, and status are defined here. The specification revision is also maintained here and can have email notifications turned on when the revisions are updated. Files may be attached to the specification. If a copy of the specification is attached in the system, then the read-only viewer allows the specification to be viewed in a special viewer that disables printing or copying of the specification. This prevents unauthorized distribution of the specification and prevents the technicians from printing the specification to use a hard-copy reference.

According to one embodiment, the present system includes functionality to drilldown on specification usage by specification, revision, customer, and time period. This is very useful when specification revisions are updated. It is also useful for traceability and customer inquiries.

FIG. 9 illustrates an exemplary tensile minimums interface 900 for use with the present system, according to one embodiment. According to one embodiment, tensile minimums can be setup by specification, alloy-temper, forging type, and orientation. The tensile minimums include functionality for (as an example):
Multiple thicknesses;
Minimum/Maximum Ultimate Tensile Strength;
Minimum/Maximum Yield Strength;
Minimum Elongation;
Test Bar Elongation (AMS QQ-A 367);
Minimum/Maximum Rockwell; and
Minimum/Maximum Conductivity.

The tensile minimums are then matched and copied onto a part production plan. Minimums from the specification can be overridden based on customer requirements.

FIG. 10 illustrates an exemplary tensile validation interface 1000 for use with the present system, according to one embodiment. FIG. 11 illustrates an exemplary tensile validation rules interface 1100 for use with the present system, according to one embodiment. FIG. 13 illustrates an exemplary lab workbench interface 1300 for use with the present system, according to one embodiment. The validation results can be viewed for every sample from an exemplary tensile lab workbench interface 1300. A validation table includes information about which rule was used and all of the criteria that were checked.

FIG. 12 illustrates an exemplary part planning interface 1200 for use with the present system, according to one embodiment. FIG. 14 illustrates an exemplary instruments and specifications interface 1400 for use with the present system, according to one embodiment.

FIG. 15 illustrates an exemplary chemistry requirements interface 1500 for use with the present system, according to one embodiment. According to one embodiment, chemistry requirements are setup for each alloy and the configuration for several alloys is included at installation.

FIG. 16 illustrates another exemplary chemistry requirements interface 1600 for use with the present system, according to one embodiment. Chemistry requirements are also configurable by specification. Each alloy can be configured with minimum and maximum component ranges for each alloy according to the specification. This is necessary, for example, because if a chemical analysis is required on the tensile lab planning, the results from a spectrometer will be validated according to the specification's requirements.

FIG. 17 illustrates a specification master interface 1700 for defining chemistry requirements, according to one embodiment. FIG. 18 illustrates a corresponding testing workbench interface 1800 with chemistry requirements imported and validated, according to one embodiment.

According to one embodiment, the present system includes administration tools. The administration tools provide for a great deal of configuration according to business requirements. This flexibility minimizes programmatic customizations that make upgrades difficult.

According to one embodiment, an administration module includes the following functionality:
a centralized user management system to maintain users;
ability to setup multiple organizations;
a menu structure that displays only the relevant menu items to each user based on their assigned modules;
the ability to customize user menus by adding, removing, and hiding functions by user;
the option to dynamically add existing and remove new functionality to the menu; and
the ability to configure the forms used in the modules, including the maintenance of fields list-of-values, enhancing data integrity and allowing each installation to be configured to requirements of each customer.

Each transaction in the software stores the username and time stamp of the transaction. When creating a certificate, the operator is required to provide their credentials since the document is electronically stamped with their stamp identification. If corrections are necessary, the certificate gets a new revision number while maintaining the previous certificates for traceability.

According to one embodiment, the present system includes security. Because the server is located in an internal network, it includes network access. Compared to web-based solutions, this approach is generally more secure and reliable. Each user logs into the software using their own account. Users are only able to see menu items that are given to them by the administrator. Users are only able to modify records based on their role. If multiple organizations are setup, then users can only see data for their organization/site. Users can be managed and assigned to one or more organizations for multi-site implementations. Users are also assigned to roles in the software, such as read-only, user, or manager. Menus are individually configurable, by an administrator, for each user. The users also have the option to hide menu items if they are setup with menu items that they do not use.

FIG. 19 illustrates an exemplary value list management interface for use with the present system, according to one embodiment. The list of values that are input into various fields in forms are managed by an administrator. The list of values can either be a list based set of values or a dynamic SQL-query based list of values, according to one embodiment. FIG. 20 illustrates an exemplary interface including a list of values corresponding to FIG. 19 for use with the present system, according to one embodiment.

FIG. 21 illustrates an exemplary parameter and field definition interface for use with the present system, according to one embodiment. An administrator, according to one embodiment, manages the search parameters and fields for each screen. FIG. 22 illustrates exemplary search functionality within a workbench interface according to definitions of FIG. 21, according to one embodiment.

FIG. 23 illustrates an exemplary menu navigation management interface 2300 for use with the present system, according to one embodiment. An administrator manages a menu navigation bar, according to one embodiment. FIG. 24 illustrates an exemplary navigation bar within an administration interface 2400 according to definitions in FIG. 23, according to one embodiment.

FIG. 25 illustrates an exemplary user management interface 2500 for use with the present system, according to one embodiment. FIG. 26 illustrates an exemplary user permissions management interface 2600 for use with the present system, according to one embodiment. An administrator manages users and user permissions and/or role groups.

FIG. 27 illustrates an exemplary user menu management interface 2700 for use with the present system, according to one embodiment. Management of a user's menu allows for forms in a navigation bar to be displayed or hidden from specific users.

FIG. 28 illustrates an exemplary certificate request management interface 2800 for use with the present system, according to one embodiment. Managing update requests to certificates allows for the certificates to have fields updated. The requests are made on the certificate forms where a dynamic set of fields is displayed and the user chooses the field, and then submits a new value to replace a current value. This helps to streamline the correction when typos or bad data are imported from the source ERP (manufacturing) system. The correction is completed by just clicking on Approve and a correction request PDF is automatically generated and emailed to the user as an attachment. The certificate itself is corrected and the new record is saved as a new revision of the document, allowing for traceability.

FIG. 29 illustrates an exemplary flexible fields management interface for use with the present system, according to one embodiment. Managing flexible fields allows the software to be configured instead of customized for specific customer requirements. This allows certain fields to be hidden, customized, tied to a list of values, read only, or nullable (allowed to be left blank), according to one embodiment. This functionality works for both text boxes and combo boxes. FIGS. 30-31 illustrate exemplary display of fields according to FIG. 29 within a workbench interface, according to one embodiment of the present system.

FIG. 32 illustrates an exemplary application options definition interface for use with the present system, according to one embodiment. Exemplary application options include input paths to external testing machines, mail server and pot, paths to Crystal reports.

FIG. 33 illustrates an exemplary test equipment definition interface for use with the present system, according to one embodiment.

Table 1 lists exemplary alloys for use with the present system, according to one embodiment.

TABLE 1
Exemplary Alloys.

| ALLOY_FAMILY | ALLOY | TEMPER |
|---|---|---|
| ALUMINUM | 2618 | T6 |
| ALUMINUM | 6063 | O |
| ALUMINUM | 7075 | T73 |
| ALUMINUM | 2024 | O |
| ALUMINUM | 5052 | O |
| ALUMINUM | 2090 | O |
| ALUMINUM | 2124 | O |
| ALUMINUM | 2195 | O |
| ALUMINUM | 2219 | T6 |
| ALUMINUM | 2324 | |
| ALUMINUM | 7055 | |
| ALUMINUM | 7475 | |
| ALUMINUM | 2618 | T61 |
| ALUMINUM | 7075 | O1 |
| ALUMINUM | 7050 | T74 |
| ALUMINUM | 6061 | O |
| ALUMINUM | 2025 | T6 |
| ALUMINUM | 2219 | O |
| ALUMINUM | 4032 | T6 |
| ALUMINUM | 5083 | |
| ALUMINUM | 6151 | |
| ALUMINUM | 7010 | |
| ALUMINUM | 7049 | T73 |
| ALUMINUM | 7050 | T7451 |
| ALUMINUM | 7129 | |
| ALUMINUM | 7149 | T7352 |
| STEEL | FX-2 | |
| ALUMINUM | 2024 | T6 |
| ALUMINUM | 7075 | T6 |
| ALUMINUM | 2124 | T6 |
| ALUMINUM | 4032 | O |
| ALUMINUM | 6061 | T6 |
| ALUMINUM | 7075 | T75 |
| ALUMINUM | 2618 | T6 |
| ALUMINUM | 6013 | |
| ALUMINUM | 6069 | F. |
| ALUMINUM | 7150 | |
| ALUMINUM | C555 | |
| ALUMINUM | C855 | |
| ALUMINUM | 7075 | T61 |
| ALUMINUM | 6061 | O |
| ALUMINUM | 7050 | T7451 |
| ALUMINUM | 7075 | T651 |
| ALUMINUM | 7175 | T74 |
| ALUMINUM | 7049 | T6 |
| STEEL | P20 | T (68 F.) |
| STEEL | P20 | T (750 F.) |
| STEEL | CX | |
| STEEL | H13 | |
| ALUMINUM | 2219 | T852 |
| ALUMINUM | 7075 | T7352 |
| TITANIUM | 6AL-4V | O |
| TITANIUM | 6AL-4V | STA |
| ALUMINUM | 2014 | T652 |
| ALUMINUM | 2014 | T6 |
| ALUMINUM | 2014 | T4 |
| ALUMINUM | 2618 | T61 |
| ALUMINUM | 6061 | F. |
| ALUMINUM | 6061 | T652 |
| ALUMINUM | 7049 | T7352 |
| ALUMINUM | 7050 | T7452 |
| ALUMINUM | 7050 | O1 |
| ALUMINUM | 7075 | T652 |
| ALUMINUM | 7175 | T7452 |
| ALUMINUM | 7175 | O1 |

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

Systems and methods for tensile testing have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

What is claimed is:

1. A system for materials testing, comprising:
a communication interface coupled to testing hardware;
an electronic user interface for facilitating the input of production requirements and a specification; and
a display device for displaying results of tests conducted on the testing hardware, wherein the results are based in part on the production requirements and specification.

2. The system according to claim 1, wherein the tests conducted on the testing hardware are facilitated by a user in response to instructions displayed on the display device.

3. The system according to claim 2, wherein the instructions are based in part on the production requirements and specification.

4. The system according to claim 1, wherein the specification is converted to digital format from a part specification defined by a manufacturer.

5. The system according to claim 1, wherein the testing hardware includes one or more of a tensile testing machine, a spectrometer, and a high resolution camera.

6. The system according to claim 1, wherein the tests conducted on the testing hardware include one or more of microstructure evaluation, grain flow analysis, tensile testing, non-destructive testing (NDT), flexture testing, testing of surface fixture, inclusion content, decarburization, structure and coercivity.

7. The system according to claim 1, wherein the specification includes one or more of minimum tensile strength, maximum ultimate tensile strength, yield tensile strength, elongation, hardness, and conductivity.

8. The system according to claim 1, wherein the results include one or more of conductivity, hardness, and chemical analysis results.

9. A method for materials testing, comprising:
receiving a specification;
receiving a production plan definition;
displaying instructions for a production plan for execution by an operator; and
outputting results of tests included in the production plan, wherein the tests are conducted on testing hardware.

10. The method according to claim 9, wherein the tests conducted on the testing hardware are facilitated by an operator in response to the displayed instructions.

11. The method according to claim 9, wherein the instructions are based in part on production requirements and the specification.

12. The method according to claim 9, wherein the testing hardware includes one or more of a tensile testing machine, a spectrometer, and a high resolution camera.

13. The method according to claim 9, wherein the tests conducted on the testing hardware include one or more of microstructure evaluation, grain flow analysis, tensile testing, non-destructive testing (NDT), flexture testing, testing of surface fixture, inclusion content, decarburization, structure and coercivity.

14. The method according to claim 9, wherein the specification includes one or more of minimum tensile strength, maximum ultimate tensile strength, yield tensile strength, elongation, hardness, and conductivity.

15. The method according to claim 9, wherein the results include one or more of conductivity, hardness, and chemical analysis results.

16. The method according to claim 9, wherein defining the production plan comprises:
receiving a part definition;
retrieving a specification corresponding to the part definition;
receiving selected tests; and
creating the production plan definition based in part on the specification and selected tests.
